(19) United States
(12) Patent Application Publication
(10) Pub. No.: US 2007/0157126 A1
(43) Pub. Date: Jul. 5, 2007

(54) Three-dimensional display and control image

(76) Inventors: Michael D. Tschirhart, Ann Arbor, MI (US); Michael J. Andrews, Plymouth, MI (US)

Correspondence Address: VISTEON, C/O BRINKS HOFER GILSON & LIONE, PO BOX 10395, CHICAGO, IL, 60610, US

(21) Appl. No.: 11/326,195

(22) Filed: Jan. 4, 2006

(51) Int. Cl. G06F 3/00

(52) U.S. Cl. 715/848; 715/700

(57) ABSTRACT

A device for controlling a plurality of electronic appliances is disclosed. The device includes a display, a processor and computer memory. The display presents a three-dimensional image. The processor is in communication with the display and the plurality of electronic appliances. The computer memory device is in communication with the processor and has a first control logic stored thereon. The first control logic is executable by the processor to form the three-dimensional image on the display. The image includes a plurality of facets having operational modes for controlling an operation of at least one of the plurality of electronic appliances.

### TECHNICAL FIELD

The present invention relates to systems and methods for controlling electronic devices and to methods for providing access to many different operating modes of the electronic devices.

### BACKGROUND OF THE INVENTION

In automobile vehicles today, a variety of electronic equipment is provided to enhance the aesthetics, control and efficiency of the vehicle. Vehicles are increasingly adding electronic equipment to the passenger compartment of the vehicle. These devices include for example, MP3 players, satellite radio, portable navigation devices, air conditioning controls, cellular phones, PDAs and other similar devices. Traditionally, these devices would be controlled through switches and/or soft keys that allow a user to access linear (list-based) interfaces. These linear interfaces allow a user to scroll through menus and sub-menus to access a particular operation mode or feature of the electronic device being controlled. In a vehicle, especially a vehicle having a plurality of electronic devices, it can be difficult to navigate through and find the particular operating mode or feature a user desires. Moreover, a user has to familiarize themselves with the particular location in a menu or sub-menu where the desired function or feature is located. Thus, conventional list based interfaces limit the safe, effective and enjoyable management of the functions and features of electronic devices. This problem is exacerbated by adding additional electronic devices into the vehicle where it is desirable, more efficient and safer to have a single interface to control all of the devices.

Therefore, a need exists for new and improved user interface that addresses the limitations of current list based interfaces. The new and improved user interface should allow a system user to easily and safely navigate through functions and features of a plurality of electronic devices.

### BRIEF SUMMARY OF THE INVENTION

In an aspect of the present invention a device for controlling a plurality of electronic appliances is provided. The device includes a display, a processor and computer memory. The display presents a first three-dimensional image. The processor is in communication with the display and the plurality of electronic appliances. The computer memory device is in communication with the processor and has a first control logic stored thereon. The first control logic is executable by the processor to form the first three-dimensional image on the display. The first image includes a plurality of facets having operational modes for controlling an operation of at least one of the plurality of electronic appliances.

In yet another aspect of the present invention, the first three-dimensional image is an oval shape.

In yet another aspect of the present invention, the first three-dimensional image is a sphere shape.

In yet another aspect of the present invention, the computer memory has a second control logic stored thereon and executable by the processor to rotate the first three-dimensional image about a first rotational axis.

In still another aspect of the present invention, the computer memory has a third control logic stored thereon and executable by the processor to rotate the first three-dimensional image about a second rotational axis.

In still another aspect of the present invention, the computer memory has a fourth control logic stored thereon and executable by the processor to move the facet to a center of the image by rotate the first three-dimensional image about at least one of the first and second rotational axis.

In still another aspect of the present invention, the computer memory has a fifth control logic stored thereon and executable by the processor to change an appearance of the facet that has been moved to the center of the image.

In still another aspect of the present invention, the computer memory has a second control logic stored thereon and executable by the processor to form and display a second three-dimensional image within the first three-dimensional image on the display device, wherein the second three-dimensional image includes facets having operational modes for controlling an operation of at least one of the plurality of electronic appliances.

In still another aspect of the present invention, the computer memory has a second control logic stored thereon and executable by the processor to form and display a second three-dimensional image adjacent the first three-dimensional image on the display device, wherein the second three-dimensional image includes facets having operational modes for controlling an operation of at least one of the plurality of electronic appliances.

In still another aspect of the present invention, the computer memory has a second control logic stored thereon and executable by the processor to display the facets horizontally across the first image.

In yet another aspect of the present invention, the computer memory has a second control logic stored thereon and executable by the processor to display the facets vertically across the first image.

In yet another aspect of the present invention, the computer memory has a second control logic stored thereon and executable by the processor to display the facets diagonally across the first image.

These and other aspects and advantages of the present invention will become apparent upon reading the following detailed description of the invention in combination with the accompanying drawings.

### BRIEF DESCRIPTION OF THE DRAWINGS

FIG. 1 is a schematic illustration of an interior of a vehicle having the display device of the present invention disposed within an instrument panel, in accordance with an embodiment of the present invention;

FIG. 2 is a front view of a display device for presenting a graphical user interface, in accordance with an embodiment of the present invention;

FIG. 3 is a plan view of a control device for controlling the graphical user interface as shown in FIG. 2, in accordance with an embodiment of the present invention;

FIG. 4 is a front view of the display device of the present invention wherein the graphical user interface is in the FM radio band mode, in accordance with an embodiment of the present invention;

FIG. 5 is a front view of the display device of the present invention wherein the graphical user interface is shown in a tuning mode, in accordance with an embodiment of the present invention; and

FIG. 6 is a perspective view of a graphical user interface in the form of a sphere, in accordance with an embodiment of the present invention.

### DETAILED DESCRIPTION OF THE INVENTION

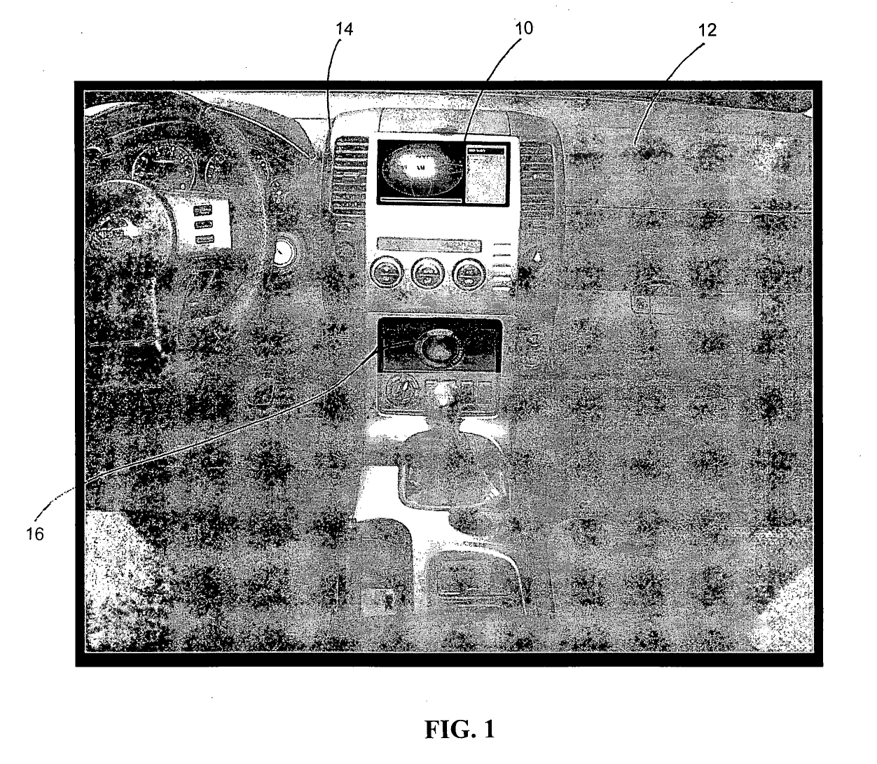

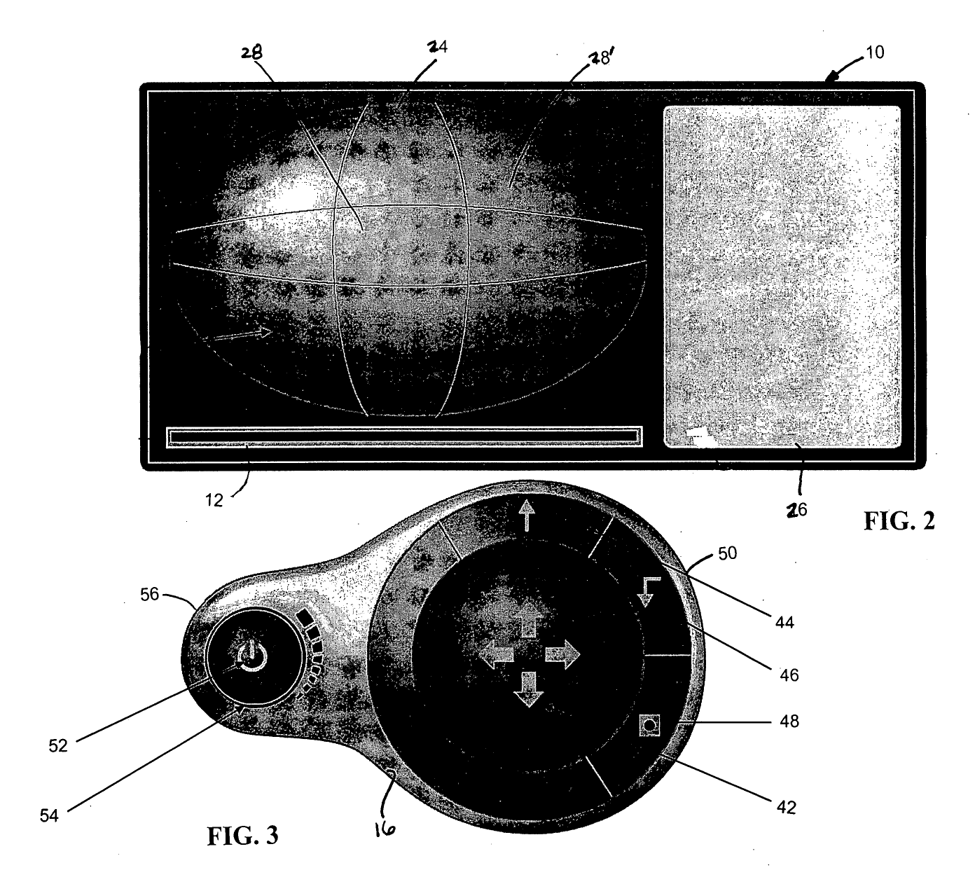

Referring now to FIG. 1, a display device 10 is shown incorporated into an instrument panel 12 in a vehicle interior, in accordance with an embodiment of the present invention. Display device 10 displays a graphical user interface (GUI) (shown in FIG. 2) for an operator of a vehicle to control a plurality of features and functions of multiple electronic devices and systems disposed within the vehicle. Display device 10 is in communication with a control unit (not shown) that may be integrated into device 10 or located remotely from device 10. The control unit includes a processor, computer memory and control logic for presenting and controlling the GUI.

Display device 10 may be located in the center stack 14 of the instrument panel or at another location within the vehicle that is accessible by the vehicle operator. Display device 10 may include a touch screen that a user may contact to manipulate the GUI. In another embodiment of the present invention, display device 10 may be controlled by a remote control device 16. Remote control device 16 may also be located in the center stack 14 and preferably positioned below display device 10. However, the present invention contemplates other locations for mounting remote control device 16 that are accessible to the vehicle operator. Remote control device 16 is hard wired to display device 10 or connected through a wireless link (i.e. RF link).

Referring now to FIG. 2, an electronic display device 10 is illustrated in detail, in accordance with an embodiment of the present invention. Display device 10 includes a LCD, TFT, plasma, CRT, or other similar electronic display. Display device 10 may be a stand alone display device or integrated into an electronic appliance. For example, display device 10 may be part of a navigational device, a radio, or other electronic device. Display device 10 may be integrated into a DVD or CD player, in which case device 10 would include a disc slot 22 for accepting optical media. Display device 10 presents a graphical user interface (GUI) 24 that is configured to control a plurality of electronic devices associated with display device 10. For example, display device 10 may be connected to a radio, a navigational device, an air conditioning system, a vehicle cruise control, DVD/CD/MP3 player and the like. GUI 24 displays a plurality of functions and features to be selected by a user to control the associated electronic devices. Display device 10 also has a text display area 26 for displaying text or other images to communicate information to the operator.

GUI 24 is preferably a three-dimensional image that has facets or surfaces 28 on which functions, modes or features for controlling various electronic components are displayed. While GUI 24 is shown in the form of an oval shaped or football shaped image, the present invention contemplates other three-dimensional shapes such as a sphere, curved surface (that is not solid or enclosed) or any similar three-dimensional geometric shape. In an embodiment of the present invention, facets 28 are disposed horizontally, vertically and diagonally across GUI 24. Advantageously, image 14 allows the user to view a plurality of functions and features at one time enabling the user to quickly move or navigate from one facet 28 to another facet 28′, for example.

Referring now to FIG. 3, a plan view of a remote control device 16 is illustrated, in accordance with an embodiment of the present invention. Control device 16 includes a track ball 42 and a plurality of switches 44, 46 and 48 disposed at a first end 50 of device 16 and a power on/off switch 52 and a volume control ring 54 at a second end 56. Track ball 42 is a spherical ball that may be rolled at least vertically and horizontally to in turn roll or move the image of GUI 24 to position facet 28 in the center of the image. Select switch or button 44 allows the user to select the facet that is in the center position or location of the image of GUI 24. The back button 46 allows the user to return to the previous selection. A record button 48 allows the user to record a media being played. On/off switch 52 allows a user to activate or deactivate display device 10. Control ring 54 allows the user to control the volume of the media selected by the user.

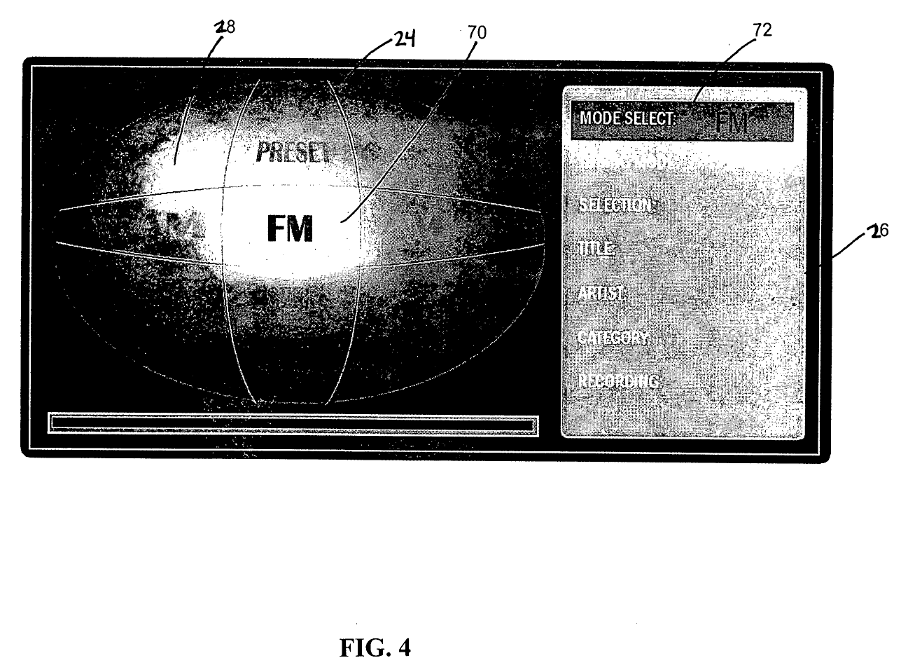

Referring now to FIG. 4, GUI 24 is shown in a first mode of operation, in accordance with an embodiment of the present invention. For example, GUI 24 is shown controlling a radio in an FM mode. While for explanatory purposes the FM mode is shown as being selected by the operator, persons of ordinary skill in the art would understand that other modes of operation and selections may be made that are unique to the particular electronic appliance being controlled. For example, if the system to be controlled by the operator is the vehicle air conditioning system then the first mode of operation displayed on facet 28 would be heat or cool, for example.

In operation, the user will rotate the image of GUI 24, using trackball 42, until the facet containing the particular band or mode is moved to the center position indicated by reference numeral 70. Once the desired mode or band is positioned at the center of the GUI image, the user depresses select button 44 on control device 16 or touches the display screen, if the display screen is a touch screen to make the selection. Upon selecting the mode or band, center facet 70 will undergo a graphical change such as the contrast of center facet 70 relative to the surrounding facets will change. For example, the center facet 70 may become brighter or darker than the surrounding facets or some other graphical change will occur. The text display area 26 provides the user with text information that conveys the current selections made via GUI 24. For example, a mode selection portion of the text display area 26 displays the mode, in this case the radio band FM, selected by the user.

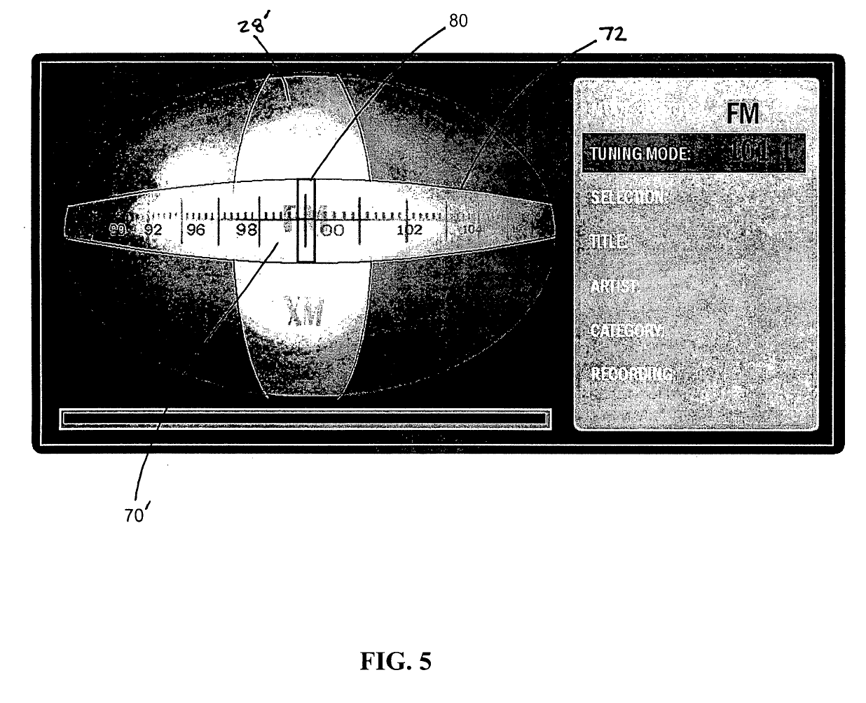

Referring now to FIG. 5, a second mode of operation is illustrated, in accordance with an embodiment of the present invention. Continuing the radio control example discussed above, the second mode of operation is a radio channel tuning mode. A user selects the tuning mode by moving/navigating to a facet 28′ having a seek, preset channels, or the like feature displayed thereon. Once the desired facet 28′ is moved to the center of the image as represented by facet 70′ the user may select the facet by actuating selection button 44 on remote control device 16. In tuning mode, the GUI 24 displays a radio frequency spectrum 72 for selecting a particular radio frequency channel. A cursor/pointer 80 is provided in center facet 70′ for selecting the particular radio frequency channel desired. In operation, the user will rotate the image of GUI 24, horizontally until cursor 80 moves over the desired frequency of the radio channel to be selected. Once the cursor 80 is over the desired radio channel, the user then makes the selection by depressing the select button 44. Of course, the present invention contemplates other second modes of operation or meta properties including balance, fade, seek/scan, and the like.

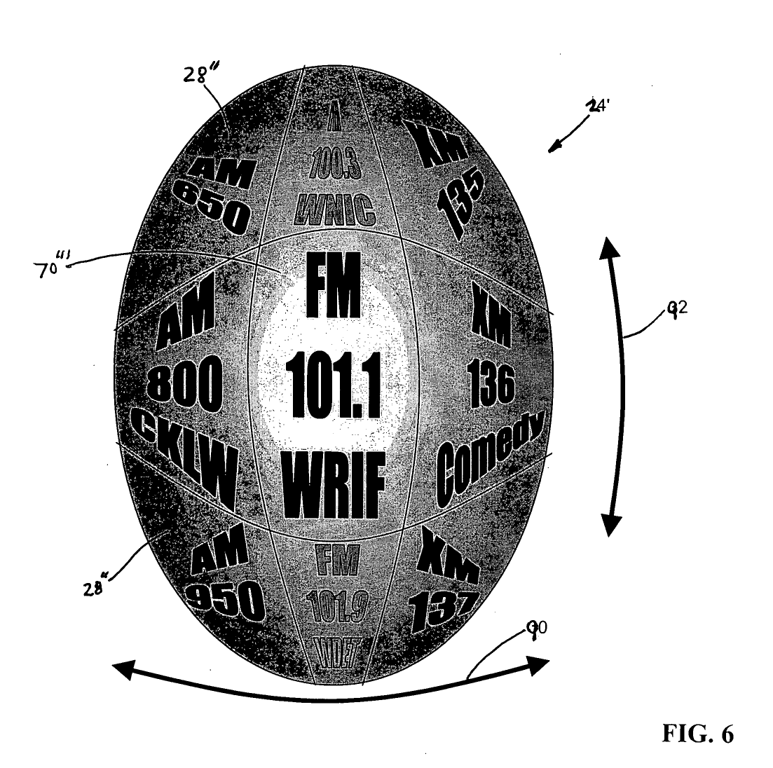

Referring now to FIG. 6, another embodiment 24′ of a shape of GUI 24 is illustrated, in accordance with the present invention. As shown, GUI 24′ is spherical. Spherical GUI 24′ has a primary rotational axis of rotation represented by arrow 90 and a secondary rotational axis of rotation represented by arrow 92. For example, in this embodiment as in the one discussed above a radio is being controlled by the spherical image of GUI 24′. However, unlike the previous embodiments discussed above the spherical image of GUI 24′ displays the radio bands (i.e. AM, FM or XM) and the radio channels on each facet 28″. The mode or bands are displayed vertically and may be navigated to by rotating the sphere along its primary axis of rotation 90. The radio channels are displayed horizontally across the sphere and may be navigated to by rotating the sphere along its secondary axis of rotation 92. Advantageously, the user does not have to select a particular band first and then tune to a particular frequency. In the present embodiment, the user may navigate by rotating the sphere along both its primary and secondary axis to position the desired facet containing both the band and radio channel in the center of the image, as represented by facet 70′″. Thus, the present invention provides a quick and efficient method for navigating through the many different features and functions of multiple electronic appliances.

The present invention contemplates other embodiments of GUI 24, 24′. For example, GUI 24 may include multiple concentric spheres or images. A user my navigate between spheres to access different features or operating modes for a particular electronic appliance under the control of GUI 24. Further, in another embodiment multiple images may be displayed in GUI 24. For example, GUI 24 may have a primary image in the shape of a sphere or the like and a secondary image in the shape of a sphere or the like disposed adjacent the primary image. The primary image would have a first set of function or modes and the secondary image would have a second set of functions or modes. For example, in the radio embodiment discussed above the primary image may have bands and radio channels and the secondary image may have balance, fade, seek, scan and preset channels and the like.

The foregoing disclosure is the best mode devised by the inventor for practicing this invention. It is apparent, however, that methods incorporating modifications and variations will be obvious to one skilled in the art of graphical user interfaces thereof. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

1. A device for controlling a plurality of electronic appliances, the device comprising:
a display for displaying a first three-dimensional image;
a processor in communication with the display and the plurality of electronic appliances; and
a computer memory device in communication with the processor having a first control logic stored thereon and executable by the processor to form the first three-dimensional image on the display, and wherein the first image includes a plurality of facets having operational modes for controlling an operation of at least one of the plurality of electronic appliances.

2. The device of claim 1 wherein the first three-dimensional image is an oval shape.

3. The device of claim 1 wherein the first three-dimensional image is a sphere shape.

4. The device of claim 1 wherein the computer memory has a second control logic stored thereon and executable by the processor to rotate the first three-dimensional image about a first rotational axis.

5. The device of claim 4 wherein the computer memory has a third control logic stored thereon and executable by the processor to rotate the first three-dimensional image about a second rotational axis.

6. The device of claim 5 wherein the computer memory has a fourth control logic stored thereon and executable by the processor to move the facet to a center of the image by rotate the first three-dimensional image about at least one of the first and second rotational axis.

7. The device of claim 6 wherein the computer memory has a fifth control logic stored thereon and executable by the processor to change an appearance of the facet that has been moved to the center of the image.

8. The device of claim 1 wherein the computer memory has a second control logic stored thereon and executable by the processor to form and display a second three-dimensional image within the first three-dimensional image on the display device, wherein the second three-dimensional image includes facets having operational modes for controlling an operation of at least one of the plurality of electronic appliances.

9. The device of claim 1 wherein the computer memory has a second control logic stored thereon and executable by the processor to form and display a second three-dimensional image adjacent the first three-dimensional image on the display device, wherein the second three-dimensional image includes facets having operational modes for controlling an operation of at least one of the plurality of electronic appliances.

10. The device of claim 1 wherein the computer memory has a second control logic stored thereon and executable by the processor to display the facets horizontally across the first image.

11. The device of claim 1 wherein the computer memory has a second control logic stored thereon and executable by the processor to display the facets vertically across the first image.

12. The device of claim 1 wherein the computer memory has a second control logic stored thereon and executable by the processor to display the facets diagonally across the first image.
